(19) United States
(12) Patent Application Publication
(10) Pub. No.: US 2004/0200505 A1
(43) Pub. Date: Oct. 14, 2004

(54) Robot vac with retractable power cord

(76) Inventors: Charles E. Taylor, Punta Gorda, FL (US); Andrew J. Parker, Novato, CA (US); Shek Fai Lau, Foster City, CA (US); Eric C. Blair, San Rafael, CA (US); Andrew Heninger, Palo Alto, CA (US); Eric Ng, San Leandro, CA (US)

Correspondence Address: FLIESLER MEYER, LLP, FOUR EMBARCADERO CENTER, SUITE 400, SAN FRANCISCO, CA, 94111, US

(21) Appl. No.: 10/799,916

(22) Filed: Mar. 11, 2004

Related U.S. Application Data
(60) Provisional application No. 60/454,934, filed on Mar. 14, 2003.
(60) Provisional application No. 60/518,756, filed on Nov. 10, 2003.
(60) Provisional application No. 60/518,763, filed on Nov. 10, 2003.
(60) Provisional application No. 60/526,868, filed on Dec. 4, 2003.
(60) Provisional application No. 60/527,021, filed on Dec. 4, 2003.
(60) Provisional application No. 60/526,805, filed on Dec. 4, 2003.

(51) Int. Cl. B08B 7/04; B08B 5/04

(52) U.S. Cl. 134/18; 15/319; 134/21

(57) ABSTRACT

A robot cleaning system uses a robot cleaner and a unit. The unit is connected to power the robot cleaner by a power cord. The robot cleaner can move around a room while being powered by the unit. In one embodiment, the unit is connected to a power socket by another power cord.

### CLAIM OF PRIORITY

This application claims priority to U.S. Provisional Application No. 60/454,934 filed Mar. 14, 2003; U.S. Provisional Application No. 60/518,756 filed Nov. 10, 2003; U.S. Provisional Application No. 60/518,763 filed Nov. 10, 2003; U.S. Provisional Application No. 60/526,868 filed Dec. 4, 2003; U.S. Provisional Application No. 60/527,021 filed Dec. 4, 2003; U.S. Provisional Application No. 60/526,805 filed Dec. 4, 2003 and this application incorporates by reference U.S. Application No. ______ entitled “Robot Vacuum” By Taylor et al., filed Concurrently. (Attorney Docket No. SHPR-01360USS)

### FIELD OF THE INVENTION

The present invention relates to a robot vacuums.

### BACKGROUND

Robot vacuums are new and growingly popular way to clean rooms. An example of a robot vacuum is the Roomba Vacuum for the iRobot Company. Since robot vacuums are typically powered by a battery, the cleaning units on the robot vacuums may not be strong enough to adequately clean a room. Conventional vacuums have relatively strong vacuum units to suck up dirt and other particulates. Because robot cleaners such as the Roomba are battery powered, they typically do not include such a powerful vacuum and may do an inadequate job cleaning rooms. It is desired to have an improved robot cleaner.

### SUMMARY

One embodiment of the present invention is a robot system. The robot system comprises a robot cleaner including a cleaning unit and a motion unit. The system also includes a unit connected to the robot cleaner by an electrical cord to provide power to the robot cleaner. The robot cleaner cleans the room while connected to the unit and the power cord is wound in as the robot cleaner gets closer to the unit.

### BRIEF DESCRIPTION OF THE DRAWINGS

FIG. 1 is a diagram of a robot system including a robot cleaner of one embodiment of the present invention.

FIG. 2 is a diagram illustrating a path of a robot cleaner unit in one embodiment of the present invention.

FIG. 3 is a diagram of the path of a robot cleaner in one embodiment of the present invention.

FIG. 4 is a diagram of an encounter of the robot cleaner with an object in one embodiment of the present invention.

### DETAILED DESCRIPTION

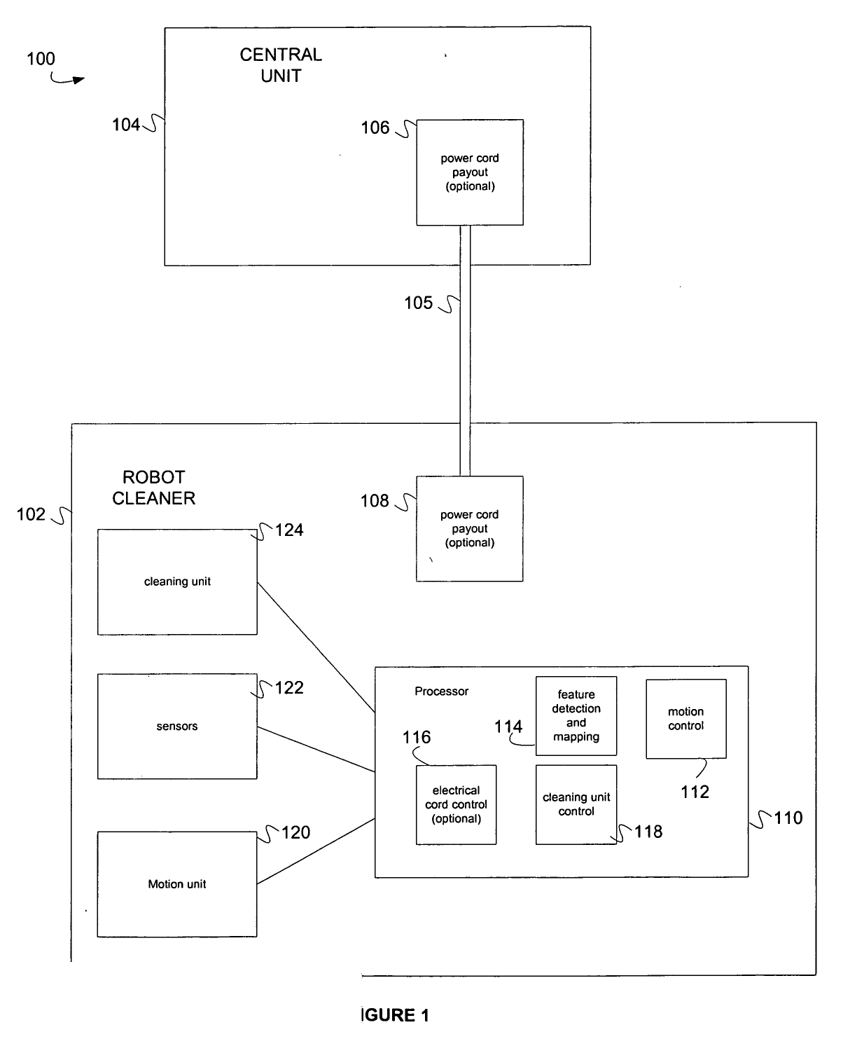

FIG. 1 illustrates a robot system 100. The robot system 100 includes a robot cleaner 102 and a unit 104, such as central unit. The robot cleaner 102 includes a cleaning unit 124 and a motion unit 120. The cleaning unit 124 can be any cleaning unit including a sweeping unit, waxing unit or a vacuum unit. The unit 104 is connected to the robot cleaner by electrical cord 105 to provide power to the robot cleaner 102. The robot cleaner can circle the unit to clean the room. The power cord can be wound in as the robot cleaner comes closer to the unit and can be wound out as the robot moves away from the unit.

In one embodiment, a power cord payout 106 is located at the unit 104. In another embodiment, the power cord payout 108 is located at the robot cleaner. The power cord payout can roll out the electrical cord 105. In one embodiment, the power cord payout maintains some level of tension on the electrical cord 105.

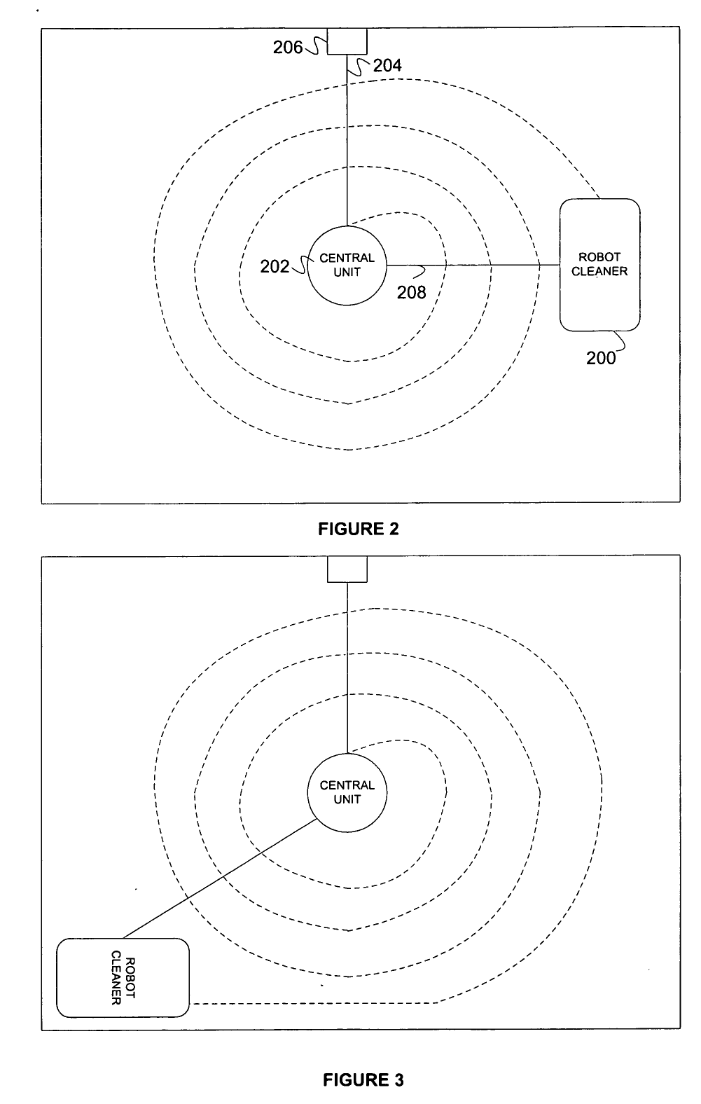

FIG. 2 illustrates an embodiment which the robot cleaner 200 circles a central unit 202. The central unit 202 is connected by another power cord 204 to an electrical socket 206. Since the robot cleaner 200 is electrically connected to the socket 206, the robot cleaner 200 can have a powerful vacuum to adequately clean a room.

The electrical cord 204 can be a flat ribbon or other shape that can be taped down or otherwise placed to the floor in order to avoid the robot cleaner 200 from becoming entangled on the power cord 204. As shown in FIG. 2, the power cord can be pulled in or out by a payout unit as the robot cleaner moves about the room. The power cord 208 can be connected to a central swivel at the central unit 208, which rotates so that the electrical cord always to faces the robot cleaner 200.

Looking at FIG. 1, the robot cleaner 102 can include sensors 122. The sensors can be used to detect objects within the room, such as walls, furniture, etc. In one embodiment, the robot cleaner 102 includes a processor 110. The processor can include a motion control unit 112 for controlling the operation of the motion unit 120. The processor 110 can also include a feature detecting and mapping unit 114 to map the room. An indication of the power cord length and orientation with respect to the central unit can also be maintained as a part of the feature detection and mapping. If an object is detected in a room, the object can be mapped. The robot cleaner can avoid wrapping the cord around the object by not circling the object. Portions of the room in the object's “shadow” can be cleaned by the robot cleaner moving back and forth so as to not tangle the power cord.

Additional feature detection and mapping information can be provided by other orientation sensors, such as a sensor associated with a wheel on the robot cleaner. In one embodiment, the cleaning unit can use control software 118. The cleaning unit control software 118 can be used for backing up the robot cleaner 102 detecting when the robot cleaner unit hits a snag.

In one embodiment, the robot cleaner 102 is able to detect an entangled condition. The processor 110 can monitor the robot cleaner to detect the entangled condition and then adjust the operation of the robot cleaner to remove the entangled condition. Robot cleaner 102 can become entangled at the sweeper or drive wheels. The entangled condition may be caused by a rug, string or other objects in the room.

The motor driving the wheels and sweeper will tend to draw a larger amount of spike in the current when the motor shaft is stalled or stopped. A back electromotive force (EMF) is created when the motor is turned by an applied voltage. The back EMF reduces the voltage seen by the motor and thus reduces the current drawn. When a rise or spike in the current is sensed at the motor, the stall in the drive wheel, and thus the entanglement condition, can be determined.

An entangled condition can be determined in other ways, as well. In one embodiment, a lack of forward progress of the robot cleaner is used to detect the entangled condition. For example, when the robot cleaner is being driven forward but the position does not change and there are no obstacles detected by the sensors 122, an entangled condition may be assume. The detection of the entangled condition can be use the position tracking software module described below.

In one embodiment, the current drawn by a motor of the robot cleaner 102 is monitored using a pin of a motor driver chip. The motor driver chip may include a pin that supplies a current proportional to the current through the motor. This current can be converted into a voltage by the use of a resistor or other means. This voltage can be converted in an analog-to-digital (A/D) converter and input to the processor. An example of a motor diver chip that includes such a current pin is the LM120H-Bridge motor driver chip. Other means to sence a current through the motor can alternately be used.

In one embodiment, when an entangled condition is sensed, the processor 110 adjusts the operation of the robot cleaner to remove the entangled condition. For example, the power to the sweeper can be turned off and/or the robot cleaner can be moved backward to remove the entangled condition. Alternately, the direction of the sweeper can be reversed. Once the entangled condition is removed, the operation of the robot cleaner can proceed. If one or more entanglements occur at a location, an obstacle can be mapped for that location and that location can be avoided.

FIG. 3 illustrates the case when the robot cleaner reaches a wall. When the robot cleaner reaches a wall of the room. The robot cleaner can go into a wall following mode. The wall following mode can move the robot cleaner to the corners of the room or cleaning a portion along the wall and then continue the circling about the central unit.

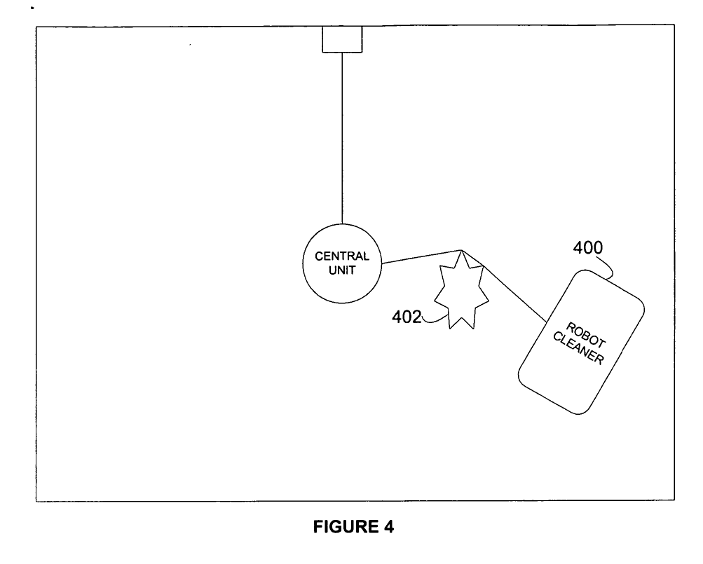

FIG. 4 illustrates an embodiment where the robot cleaner 400 gets partially entangled by an object. In one embodiment, the robot cleaner prevents the power cord from completely wrapping around an object 402 on the floor. In this embodiment, the robot cleaner uses the mapping and tracking functions to not wrap around the object. For example, contact with the object can be determined by the tension in the power cord or by the change in direction of the robot cleaner. In one embodiment, the robot keeps track of its motion to determine direction changes caused by the power cord contacting objects on the floor. Keeping track of the direction can be done by monitoring a motion sensor such as a motion sensor associated with the motion unit of the robot unit. In one embodiment, the robot cleaner, once a contact is determined, will clean back-and-fourth behind the object 402 while ensuring that the power cord is not entangled by the object 402.

One embodiment of the present invention is a robot cleaner including a cleaning unit and a motion unit. The robot system also includes a central unit connected to the robot cleaner by a power cord to provide power to the robot cleaner. The central unit is connectable to a power socket by another power cord wherein the robot cleaner is adapted to clean a room. The robot system includes a power cord payout.

The foregoing description of preferred embodiments of the present invention has been provided for the purposes of illustration and description. It is not intended to be exhaustive or to limit the invention to the precise forms disclosed. Many embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalence.

1. A robot system comprising:
a robot cleaner including a cleaning unit, and a motion unit; and
a unit connected to the robot cleaner by an electrical cord to provide power to the robot cleaner wherein the robot cleaner cleans the room while connected to the unit and wherein the power cord is wound in as the robot cleaner gets closer to the unit.

2. The robot system of claim 1, wherein the unit is a central unit, wherein the robot cleaner moves around the central unit to clean the room.

3. The robot system of claim 1, wherein the unit is connected to a power socket by another power cord.

4. The robot system of claim 1, wherein the robot cleaner includes a payout.

5. The robot system of claim 1, wherein the central unit includes a payout.

6. The robot cleaner of claim 1, wherein the robot cleaner prevents the power cord from completely wrapping around an object on the floor.

7. The robot cleaner of claim 6, wherein the robot cleaner keeps track of its motion to determine motion changes caused by the power cord contacting objects on the floor.

8. The robot cleaner of claim 6, wherein the robot cleaner cleans back and forth in region behind the object.

9. The robot cleaner of claim 1, wherein the robot cleaner includes processor.

10. The robot cleaner of claim 9, wherein the processor controls the motion unit.

11. A method comprising:
revolving a robot cleaner about a central unit, the robot cleaner being connected to the central unit by an power cord, the robot cleaner being connected by the power cord to the central unit, wherein the robot cleaner circles the central unit to clean the room; and
winding in the power cord as the robot gets closer to the central unit.

12. The method of claim 11, wherein the central unit is connected to a power socket by another power cord.

13. The method of claim 11, wherein the robot cleaner includes a payout.

14. The method of claim 11, wherein the central unit includes a payout.

15. The method of claim 11, wherein the robot cleaner prevents the power cord from completely wrapping around an object on the floor.

16. The method of claim 15, wherein the robot cleaner keeps track of its motion to determine motion changes caused by the power cord contacting objects on the floor.

17. The method of claim 15, wherein the robot cleaner cleans back and forth in region behind the object.

18. The method of claim 1, wherein the robot cleaner includes processor.

19. The method of claim 18, wherein the processor controls the motion unit.

20. A robot system comprising:
a robot cleaner including a cleaning unit and a motion unit; and
a unit connected to the robot cleaner by a power cord to provide power to the robot cleaner, the unit being connectable to a power socket by another power cord wherein the robot cleaner is adapted to clean a room and wherein the robot system includes a power cord payout.

21. The robot system of claim 20, wherein the payout is on the robot cleaner.

22. The robot system of claim 20, wherein the payout is on the unit.

23. The robot system of claim 20, wherein the robot cleaner circles the unit to clean the room.

24. The robot cleaner of claim 23, wherein the robot cleaner prevents the power cord from completely wrapping around an object on the floor.

25. The robot cleaner of claim 24, wherein the robot cleaner keeps track of its motion to determine motion changes caused by the power cord contacting objects on the floor.

26. The robot cleaner of claim 24, wherein the robot cleaner cleans back and forth in region behind the object.

27. The robot cleaner of claim 20, wherein the robot cleaner includes processor.

28. The robot cleaner of claim 20, wherein the processor controls the motion unit.
